(19) United States
(12) Patent Application Publication
(10) Pub. No.: US 2007/0198857 A1
(43) Pub. Date: Aug. 23, 2007

(54) Software execution protection using an active entity

(75) Inventor: Nikolco Gidalov, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,554

(22) PCT Filed: Dec. 6, 2004
(86) PCT No.: PCT/IB04/52674

§ 371 Date: Jun. 16, 2006

(30) Foreign Application Priority Data
Dec. 22, 2003 (EP) 03104884.6

(51) Int. Cl. G06F 12/14

(52) U.S. Cl. 713/193

(57) ABSTRACT

The invention relates to encrypting of at least part of a computer program element for enabling protecting execution of said computer program element, comprising extracting at least one static resource of said computer program element (step 102), and encrypting said static resource with a first key (314, step 106), and decrypting of said encrypted static resource, comprising obtaining said static resource (406) encrypted with a first key, in a first entity, providing said encrypted static resource to a second entity (step 208), obtaining said static resource (406) encrypted with a first key (step 218), obtaining a second key (422, step 216), decrypting said encrypted static resource, using said second key (step 222), providing said static resource to the first entity (step 228), and obtaining by said first entity said static resource from the second entity (step 210).

The present invention relates in general to prevention of execution of computer program code, and in particular to encrypting and decrypting static data by using an active entity.

Strong execution protection methods can make use of a so called hardware dongle, as an example of one type of active entity, connected to, for instance, a parallel or a serial port, such as the USB (Universal Serial Bus) port or the printer port of, for instance, a PC (Personal Computer). A dongle is typically a passive element but can contain programmable memory loaded with several encryption/decryption keys. Information can be exchanged between the PC and the dongle. Such a dongle can for example be used in the following two ways:

1. For protection of execution of software, a shell program is created around the software to be protected. In the process of creating the shell, the original software is completely or partially encrypted in dependence of the keys from the dongle, after which the encryption is embedded in the shell. The created shell is thus based on the keys from the dongle but also on the algorithm used to decrypt the software. When the shell is started, it retrieves the keys from the dongle, extracts the encrypted software, decrypts said encrypted software and runs the original software. In the case the dongle is not present or in case a different dongle, containing different keys, is used, the decryption fails.

2. Also, for protection of execution of software, the entry-point of the original program can be replaced with the entry-point of a procedure. A logical function is provided and retrieves the keys from the dongle. Based on the retrieved keys, complex logic is arranged to decide whether the dongle is the correct dongle, or not. After a successful dongle identification the function calls the original program entry-point, which enables execution of the original software.

There are however several disadvantages with the mentioned methods:

The communication content of the different communication sessions between the PC and the dongle is usually the same, which implies that by wiretapping said communication it is possible to retrieve the protocol and the keys, and later emulate the dongle in either hardware or software, without the need for the original dongle.

After the dongle is identified, the entry-point of the original program is called, and the original program is provided in the memory as is. The experienced user can write the program back to the portable executable of said program.

There is usually one, or several, if-instructions in the dongle checking code, which can be easily replaced by using a reversed logic.

Security tools in general and hardware dongles are moreover discussed in G. Hachez, “A comparative study of software protection tools suited for E-commerce with contributions to software watermarking and smart cards” Doctor's Thesis, UCL, Louvain-La-Neuve, Belgium, March, 2003.

According to this document recent hardware dongle versions can be plugged into a USB port and usually embed a CPU of a smart card. These versions contain a small micro-controller that will return a different value to each challenge. The software will regularly interrogate the dongle with a challenge and verify that the answer is correct. The most advanced dongles contain a small micro-controller with a small amount of memory. In this case some critical parts of the software are executed within the dongle.

The methods of the hardware dongle versions as discussed above have the following drawbacks. Firstly, there is a risk that removing all checks of the dongle in the software to be protected can be successful. Secondly, there is a risk that the dongle is emulated by an intruder.

There is thus a need for a software execution protection method for which the software cannot be run even after removal of the checks for an active entity, such as a dongle in the software. There is further a need for a method that does not comprise single if-then instructions depending on whether the correct entity is present or not.

It is an object of the present invention to provide protecting execution of a computer program element by using encryption of static resources of said computer program element.

According to a first aspect of the present invention, this object is achieved by a method of encrypting at least part of a computer program element for enabling protecting execution of said computer program element, comprising the steps of:
extracting at least one static resource of said computer program element, and
encrypting the at least one static resource with a key.

According to a second aspect of the present invention, this object is also achieved by a computer program encryption device for encrypting at least part of a computer program element for enabling protecting execution of said computer program element, being arranged to:
extract at least one static resource of said computer program element, and
encrypt the at least one static resource with a key.

According to a third aspect of the present invention, this object is also achieved by a computer program product comprising a computer readable medium, having thereon computer program code means, to make a computer execute, when said computer program code means is loaded in the computer:
extracting of at least one static resource of said computer program element, and
encrypting the at least one static resource with a key.

According to a fourth aspect of the present invention, this object is also achieved by a computer program element comprising computer program code means to make a computer execute, when said computer program code means is loaded in the computer:
extracting of at least one static resource of said computer program element, and
encrypting the at least one static resource with a key.

According to a fifth aspect of the present invention, this object is also achieved by a computer program product comprising a computer readable medium, having thereon computer program code means comprising:
at least one static resource encrypted with a key.

According to a sixth aspect of the present invention, this object is also achieved by a computer program element comprising computer program code means comprising:
at least one static resource encrypted with a key.

According to a seventh aspect of the present invention, this object is also achieved by a method of decrypting at least part of a computer program element for enabling execution of said computer program element, comprising the steps of:
obtaining at least one static resource encrypted with a first key, in a first entity,
providing said at least one encrypted static resource to a second entity, and
obtaining by said first entity said at least one static resource from the second entity, where the encryption according to the first key has been decrypted by using a second key.

According to a eighth aspect of the present invention, this object is also achieved by a method of decrypting at least part of a computer program element for enabling execution of said computer program element, comprising the steps of:
obtaining at least one encrypted static resource from a first entity, which at least one static resource has been encrypted by using a first key,
obtaining a second key,
decrypting said at least one encrypted static resource, by using said second key, and
providing said at least one static resource to the first entity.

According to a ninth aspect of the present invention, this object is also achieved by a computer program decryption device for decrypting at least part of a computer program element for enabling execution of said computer program element, said device being arranged to:
obtain at least one static resource encrypted with a first key,
provide said at least one encrypted static resource to a second entity, and
obtain from the second entity said at least one static resource, where the encryption according to the first key has been decrypted by using a second key.

According to a tenth aspect of the present invention, this object is also achieved by a computer program decryption device for decrypting at least part of a computer program element for enabling execution of said computer program element, arranged to:
obtain at least one encrypted static resource from a first entity, which at least one static resource has been encrypted by using a first key,
obtain a second key,
decrypt said at least one encrypted static resource, by using said second key, and
provide said at least one static resource to the first entity.

According to a eleventh aspect of the present invention, this object is also achieved by a computer program product comprising a computer readable medium, having thereon computer program code means, to make a computer execute, when said program code means is loaded in the computer:
obtaining at least one static resource encrypted with a first key, in a first entity,
providing said at least one encrypted static resource to a second entity, and
obtaining by said first entity said at least one static resource from the second entity, where the encryption according to the first key has been decrypted by using a second key.

According to a twelfth aspect of the present invention, this object is also achieved by a computer program element comprising computer program code means to make a computer execute, when said computer program code means is loaded in the computer:
obtaining at least one static resource encrypted with a first key, in a first entity,
providing said at least one encrypted static resource to a second entity, and
obtaining by said first entity said at least one static resource from the second entity, where the encryption according to the first key has been decrypted by using a second key.

According to a thirteenth aspect of the present invention, this object is also achieved by a computer program product comprising a computer readable medium, having thereon computer program code means, to make a computer execute, when said program code means is loaded in the computer:
obtaining at least one encrypted static resource from a first entity, which at least one static resource has been encrypted by using a first key,
obtaining a second key in a second entity,
decrypting said at least one encrypted static resource, by using said second key, and
providing said at least one static resource to the first entity.

According to a fourteenth aspect of the present invention, this object is also achieved by a computer program element comprising computer program code means to make a computer execute:
obtaining at least one encrypted static resource from a first entity, which at least one static resource has been encrypted by using a first key,
obtaining a second key in a second entity,
decrypting said at least one encrypted static resource, by using said second key, and
providing said at least one static resource to the first entity.

The general idea behind the present invention is to protect execution of computer program code by using encrypting of a computer program element of a static resource within said computer program code. The idea further relies on the usage of two entities during decrypting of said encrypted a static resource, wherein communication between said two entities is at least partly encrypted.

The present invention has the following advantages:

1. It provides protecting execution of a computer program code by encrypting at least one static resource that is crucial for the execution of said computer program code.

2. The process of decryption requires a first and a second entity.

3. The computer program code cannot be executed within the first entity even after removal of requests for the second entity.

Direction of the dependent claims and the advantages thereof:

Claim 2 is directed toward storing the at least one encrypted static resource in said computer element. This claim has the advantage that resources that are needed during execution of a computer program element can be encrypted.

Claims 3, 11, 18 and 23 are directed toward using a public key and a private key of a public/private key pair. The advantage being that one key is needed to decrypt data that was encrypted by the other key.

Claims 4 and 12 are directed toward having the public key in a computer program element and computer program code means, respectively. These claims have the advantage of enabling the usage of a secure private key for decrypting data that have been encrypted by using the public key.

Claim 5 is directed towards obtaining the private key, corresponding to the public key, and storing said private key in an entity separate from an entity in which a computer program element is provided. This claim has the advantage of dramatically enhancing the security of the protection of execution by enabling separation of the two entities.

Claim 6 is directed towards extracting at least one static resource from a position in a computer program element and storing the encrypted resource in said position. This is advantageous as firstly, the original information is not available and secondly, no other part or element is affected by the storing of the encrypted resource.

Claims 15 and 20 are directed toward obtaining a third key and encrypting/decrypting of at least one static resource by using said third key. These claims carry the advantage that the static resource sent by one entity to another entity, can be encrypted with said third key.

Claims 16 and 24 are directed towards using a third key that is a random session key. The advantage with a key being symmetric is that the same key can be used for encryption and decryption, which limits the number of used keys.

Claims 17, 21 and 22 are directed towards further using the first key for encrypting/decrypting the third key and the at least one encrypted static resource. This has the advantage that the third key can be sent encrypted from one entity to the other, enabling enhanced security of the encryption of the static data by using the third key.

These and other aspects of the invention will be apparent from and elucidated with reference to the embodiments described hereinafter.

It should be emphasized that the term “comprises/comprising” when used in this specification is taken to specify the presence of stated features, integers, steps or components, but does not preclude the presence or addition of one or more other features, integers, steps, components or groups thereof.

The present invention will be more clearly understood from the following description of the preferred embodiments of the invention read in conjunction with the attached drawings, in which:

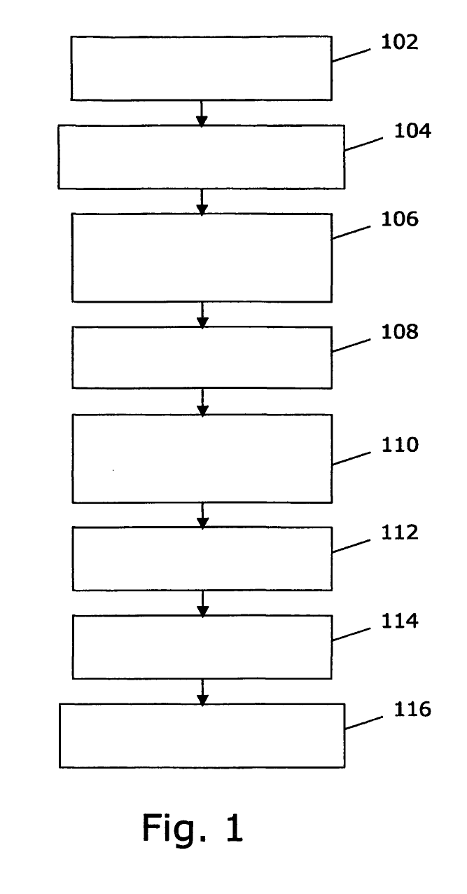

FIG. 1 presents a flow-chart of a method of encrypting according to a preferred embodiment of the present invention;

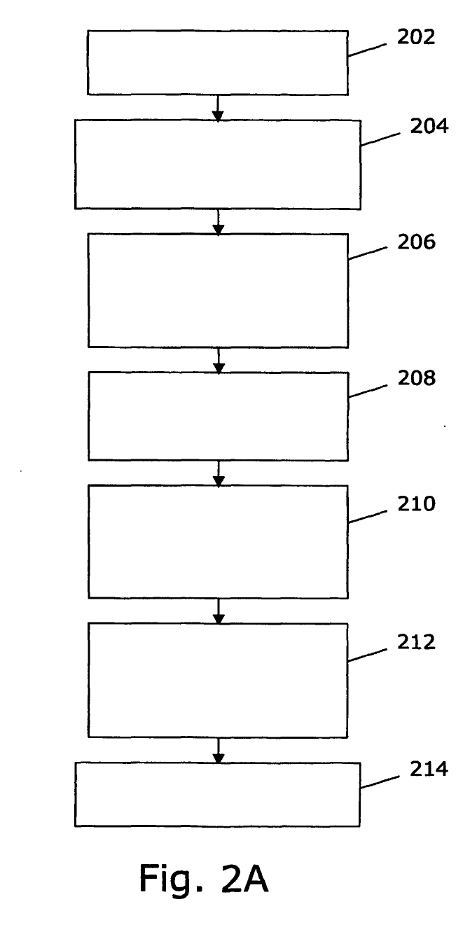

FIG. 2A presents a flow-chart of a method of decrypting according to a preferred embodiment of the present invention, performed in a device having the computer program code;

FIG. 2B presents a flow-chart of a method of decrypting according to a preferred embodiment of the present invention;

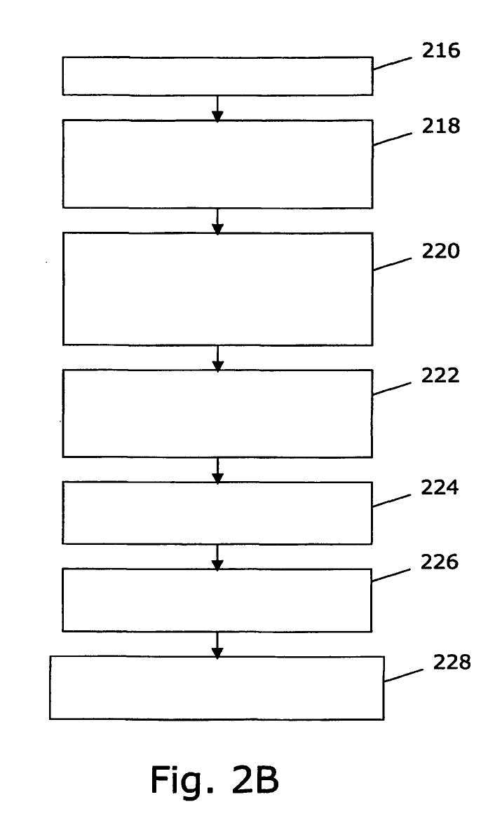

FIG. 3 schematically illustrates encryption of a program code according to the present invention;

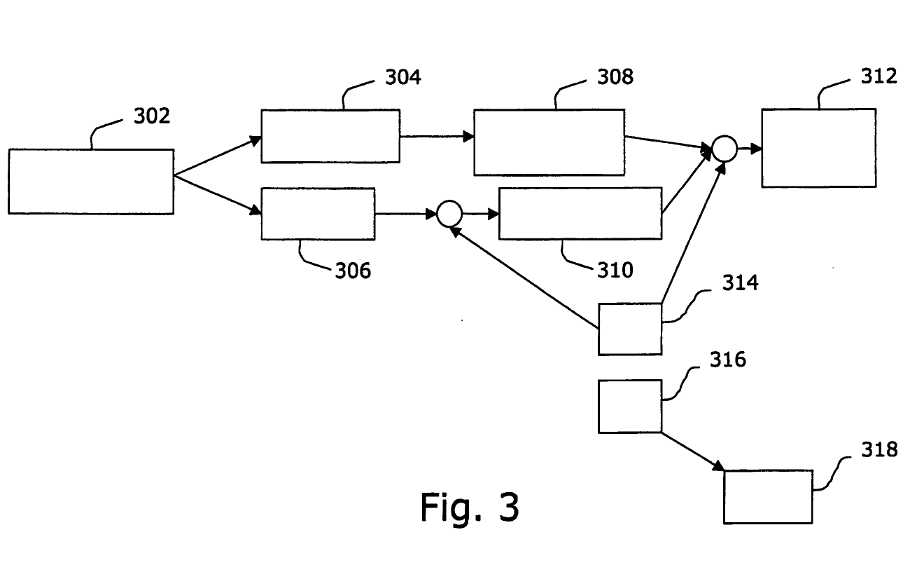

FIG. 4 schematically illustrates decryption of a protected program code according to the present invention;

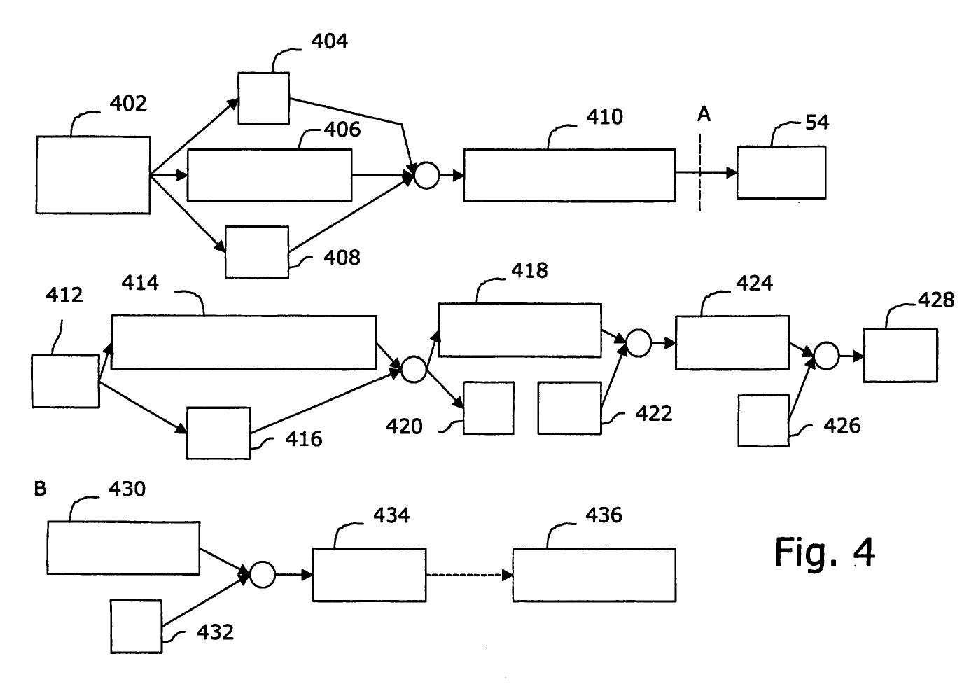

FIG. 5 schematically presents a computer and a dongle, which two entities communicate during decrypting of encrypted data;

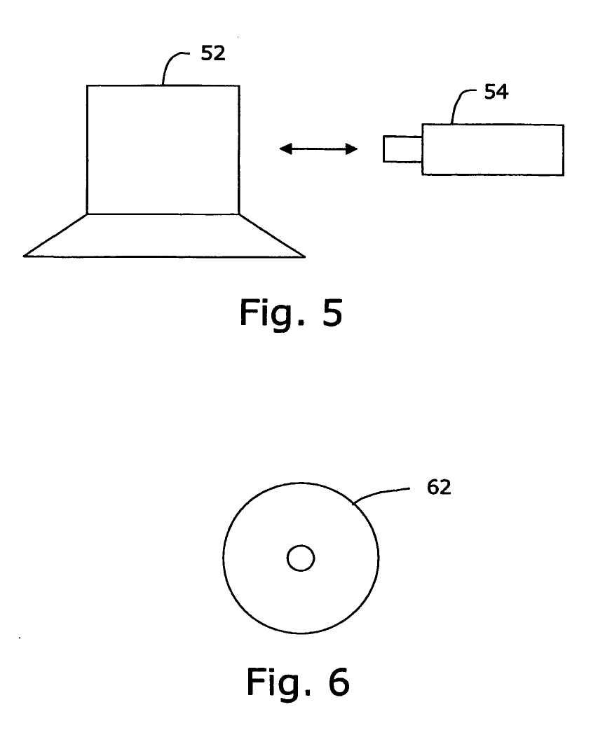

FIG. 6 shows a computer program product, having thereon computer program code means, related to the present invention.

The present invention relates to protecting execution of computer program code by encrypting and decrypting static resources of said computer program code.

The encryption and decryption uses Public Key Cryptography architecture and requires accessing the source code of the computer program code to be protected.

According to one embodiment of the present invention two different entities are used in the process of decrypting encrypted information. FIG. 5 presents one embodiment of the present invention of these two different entities. A computer such as a personal computer 52, represents a first entity and an active dongle 54, represents the second entity. These two entities are arranged to send/receive information during the decrypting steps of the process.

Instead of a dongle, a security chip can be used. This security chip can be integrated in the computer platform.

The active dongle is typically equipped with a small processor that can run simple symmetric and asymmetric encryption/decryption algorithms. The interface between the two entities, here the computer and the active dongle, can be USB (Universal Serial Port), a network, or another communication channel. The communication between the computer and the active dongle is based on the client-server model.

Before the computer program code to be protected is distributed on the market, at least part of the static data are extracted and encrypted by using the public key of the active dongle, and replaced in the source code as encrypted data. Upon compilation and running the computer program code, only the dongle with the corresponding private key can decrypt the data prior to using the data in the computer program code.

As is described below, encryption is typically carried out elsewhere independent of said computer. As is well known for a person skilled in the art encrypting and decrypting of information are related to each other, in a way similar to a key and a lock, being related. Here, the process of encrypting is performed so that a communication channel between the computer and the dongle is established for decrypting the encrypted data.

According to one embodiment of the present invention the process of decrypting starts within the computer, having loaded decrypted program code, and continues by sending information over the communication channel to the dongle, where the decrypting process further continues, followed by the dongle sending information back to the computer, at which entity the program code eventually can be executed.

The invention will now be described starting by referring to FIG. 1 presenting a flow-chart of encryption of at least part of a computer program element together with FIG. 3 schematically illustrating encryption of a computer program code. This encryption is typically carried out within a third entity different from the above mentioned two entities.

For encrypting program code, at least some static data 306, is extracted, step 102, from the original program code 302. The remains of said original program code 302, that is the original program code 302, without the extracted static data 306, here represented by the program code 304, is thus also created. In this embodiment the static data of the original program can be of any type, for instance, strings, definitions, initial variable values, images, constants, format-related static data or other static resources.

Having extracted the static data 306, a first and a second key in the form of a pair of encryption/decryption keys (a public key Kpb 314, and a private key Kpr 316) is generated, step 104. As is well known to a person skilled in the art, either one of the two keys can be used to encrypt data, and similarly either one of them can be used to decrypt data, but once one key is chosen to, for example, encrypt data only the other one can be used to decrypt said encrypted data.

Here, the static data 306, is encrypted, step 106, by using the public key Kpb 314, as an encryption key, creating the static data encrypted with said public key (Static data)Kpb 310. In order to provide the communication channel mentioned above, between the first entity, the computer and a second entity, the dongle, the program code 304, is changed, step 108, to achieve a modified program code 308. This communication channel will thus be used during the decrypting of data, which will be described below.

According to this embodiment of the present invention, each piece of static data that is extracted, step 102, at a certain position of the program code, is replaced by an encrypted copy of said data. This is performed by storing the encrypted data, step 110, in the original program code, preferably but not necessarily at the position at which the non-encrypted data was present in the original program code, 102. Having stored the encrypted static data in the program code, the public key Kpb 314, is stored, step 112, in the program code to obtain, step 116, a protected program code 312.

The private key Kpr 316, that corresponds to said public key Kpb 314, is stored in the dongle 318.

The protected program code 312, obtained thus contains pieces of encrypted static data, which encrypted static data efficiently prevents the program code from being executed, without prior decrypting said static data.

It is obvious that only certain parts of the program code elements, that is the ones that are crucial for the execution of the program need to be encrypted. This implies that not all static data needs to be encrypted in order to prohibit the functioning of entire parts of computer program code.

By decrypting pieces of the computer program code as such, the computer program code cannot be executed solely by cracking single if-then statements. This is in contrast to shell-like encryption methods, wherein the program code is to a large extent left un-encrypted but a shell preventing execution of said program code is encrypted. By cracking the single shell execution of the program within the shell is enabled.

In the following will be described decrypting of encrypted computer program code upon execution of the encrypted program code.

As mentioned above, in order to prevent execution of program code by an unauthorized party without the access to the dongle, encryption of critical program code elements is sufficient. Without the ability to execute key parts of the program code the function of the program code is not realized, at least not in full.

As only critical parts are encrypted, the unencrypted parts can however be executed. Upon executing the program code, the method that is described below is used for each piece of program code element. For each such piece, a communication session is started and information is communicated over the communication channel between the computer and the dongle. Moreover, for each such session a session key is generated as will be explained in more detail below.

In the following a more detailed description of decrypting static data, upon executing computer program code, is outlined, with reference being made to FIGS. 2A, 2B, 4 and 5.

According to this embodiment of the present invention, performing execution of the protected computer program code 402, is started in the computer. In the protected computer program code the computer locates static data (Static data)Kpb 406, encrypted with the public key Kpb 314, from FIG. 3. Also, the computer retrieves the stored public key Kpb 408, in the protected computer program code.

Having encountered encrypted static data, a third key in the form of a random session key Ks 404, is generated, step 202.

The encrypted static data 406, is then combined, step 204, with the generated random session key Ks 404, after which the combination of encrypted static data 406, and the session key Ks 404, is encrypted, step 206, by using the public key 406, thus generating an encrypted combination ((Static data)Kpb+Ks)Kpb 410, of encrypted static data 406, and said session key Ks 404.

Having generated this encrypted combination 410, said encrypted combination 410, is sent, step 208, to the dongle 54. The vertical dotted line A, in FIG. 4, denotes the interface between the computer 52 and the dongle 54.

The dongle can be connected to the computer by using a port of the computer or by using a connection over a network of any kind, for instance the Internet.

Subsequently, in step 210, the computer 52, receives from the dongle 54=412, static data (Static data)Ks 430, decrypted from the public key Kpb 314, from FIG. 3, but encrypted with a random session key Ks 426. The computer then decrypts, step 212, the encrypted static data by using a session key Ks 432.

As the random session key is a symmetric key, encrypting and decrypting is performed by using the same key. This implies that the random session key 426, the session key 432, and the random session key Ks 404, are the same keys.

Upon decrypting, the static data 434, is obtained, step 214, which static data 434, is used upon request during the execution of the program code 436.

Above was described the method in a computer of decrypting encrypted static data. Below is now described the method in the dongle of decrypting encrypted static data.

According to this embodiment of the present invention the dongle 54, firstly obtains, step 216, the private key Kpr 316 in FIG. 3, during the method of encrypting static data. Secondly, it receives, step 218, an encrypted combination ((Static data)Kpb+Ks)Kpb 410, of 1) static data, 406, encrypted with the public key, and 2) the session key Ks 404, where said combination is encrypted with the public key Kpb 408. From the dongle 54, said encrypted combination ((Static data)Kpb+Ks)Kpb 414, and the private key Kpr 416, are extracted. Now, by using the private key 416, the encrypted combination 414, is decrypted, step 220, generating the session key Ks 420, and the static data (Static data)Kpb 418, encrypted with the public key Kpb 408. Following this decryption, the encrypted static data 418, is decrypted, step 222, by again using the private key Kpr 422, which is the same key as referred to the private key 416. Upon this decrypting, step 222, decrypted static data 424, is obtained, step 224.

The dongle has thus obtained decrypted static data. Now the decrypted static data 424, is again encrypted, step 226, but at this step by using the session key 426, which key is obtained from decrypting the encrypted combination, step 220.

Obtained is thus the static data decrypted from the initial encryption performed by using the public key Kpb 314 in FIG. 3, but encrypted by using the session key 426. This encrypted static data (Static Data)Ks 428, is now sent, step 228, from the dongle 54, to the computer 52, over the dongle-computer interface as indicated by B in FIG. 4.

According to one embodiment of the present invention this interface B is the dongle-computer USB interface. This interface can however as an alternative contain a network, such as the Internet, another network, with one or more other computers, or a communication channel of any type.

FIG. 6 shows a computer program product 62, that has computer program code means stored thereon. This computer program product can be of any type, for instance a Compact Disc (CD), a diskette, a Digital Versatile Disc (DVD), solid-state memory, or a hard disk.

The protecting execution of a computer program code can be used to prevent unauthorized access to any hardware that is controlled by or in some way dependent on said computer program code. Using the proper active entity, i.e. the proper dongle, accordingly authorizes access to said hardware.

The invention can further be varied in many ways, as described below.

One alternative to the embodiment as presented above is to make use of a security chip as the second entity. It is hence understood that the security chip and said computer are two discrete entities, even though one might be positioned within the other. One example of a security platform involving security chips is the TCPA/Palladium platform, which platform is well suited to be used in this alternative embodiment.

In another embodiment of the present invention protecting execution of a computer program code is enabled by using an active entity of the type of another computer program code. This is thus an alternative to the embodiments in which a security chip or a dongle is used for the decryption of encrypted static resources.

In a different embodiment the order of the steps of the method of encrypting static data can be changed and some steps can even be deleted without deferring from the scope of protection of this present invention. For instance, the step of changing program code, step 108, can be performed prior to the step of generating public and private keys, step 104.

In another embodiment of the present invention, the method of decrypting static data comprises sending the encrypted data by a computer to a dongle, in which the data is decrypted by using a private key and further returned to the computer. In this embodiment there is no usage of a session key.

In yet another embodiment of the present invention, the method of decrypting static data comprises sending by a computer to a dongle the encrypted data and a session key. The dongle decrypts the static data, encrypts the static data by using the session key and returns the data to the computer. This embodiment does not use the public key to encrypt the combination of the session key and the encrypted static data.

In yet another embodiment of the present invention the method of decrypting the static data the session key and the encrypted static data are encrypted separately by using the public key. There is hence no encrypted combination of session key and encrypted static data.

In an alternative of the embodiment as mentioned above, the session key only is encrypted by the computer, whereas the already encrypted static data is sent to the dongle as is.

In yet another embodiment the computer program decryption device is a distributed computer device comprising several computers.

In yet another embodiment of the present invention, the static data extracted at a certain position of a computer program element is stored at a different position of the same or a different computer program element. The unencrypted static data is extracted from the element and is no longer available at its position.

In still yet another embodiment the generation of the session key during decrypting encrypted static data, is performed by the computer, on order from the program code.

In still yet another embodiment, the generation of the session key during decrypting encrypted static data, is performed by the program code before encountering a new piece of encrypted static data.

In still yet another embodiment, the first entity is any type of computer, such as a PDA (Personal Digital Assistant), a palm top computer, a lap top computer, a personal computer, a gaming computer, a computer server, or similar.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. A single processor or other (programmable) unit may also fulfill the functions of several means recited in the claims.

In the device claim enumerating several means, several of these means can be embodied by one and the same item of hardware. The mere fact that certain measures are recited in mutually different dependent claims does not indicate that a combination of these measures cannot be used to advantage.

1. A method of encrypting at least part of a computer program element for enabling protecting execution of said computer program element, comprising the steps of:
extracting at least one static resource (306) of said computer program element (step 102), and
encrypting the at least one static resource (306) with a key (314, step 106).

2. Method of encrypting according to claim 1, further comprising the step of:
storing the at least one encrypted static resource (310) in said computer program element (step 110).

3. Method of encrypting according to claim 1, in which the key (314) is a public key of a public/private key pair.

4. Method of encrypting according to claim 3, further comprising the step of:
storing the public key (314) in a computer program element (step 112).

5. Method of encrypting according to claim 3, further comprising the step of:
obtaining the corresponding private key (316), and
storing said private key (316) in an entity (318) separate from an entity in which the computer program element is provided (step 114).

6. Method of encrypting according to claim 1, wherein the step of extracting (step 102) comprises extracting the at least one static resource (306) from a certain position in the program element and the step of storing (step 110) comprises storing the encrypted static resource (310) in said position.

7. Computer program encryption device for encrypting at least part of a computer program element for enabling protecting execution of said computer program element, arranged to:
extract at least one static resource (306) of said computer program element (302, step 106), and
encrypt the at least one static resource (306) with a key (314, step 106).

8. Computer program product comprising a computer readable medium, having thereon computer program code means, to make a computer execute, when said program code means is loaded in the computer:
extracting of at least one static resource (306) of said computer program element (302, step 102), and
encrypting the at least one static resource (306) with a key (314, step 106).

9. Computer program element comprising computer program code means to make a computer execute, when said computer program code means is loaded in a computer,
extracting of at least one static resource (306) of said computer program element (302, step 102) and
encrypting the at least one static resource (306) with a key (314, step 106).

10. Computer program product comprising a computer readable medium, having thereon computer program code means comprising:
at least one static resource encrypted with a key (310).

11. Computer program product according to claim 10, where said key (314) is a public key of a public/private key pair.

12. Computer program product according to claim 11, wherein said computer program code means further comprises:
said public key (314).

13. Computer program element comprising computer program code means comprising:
at least one static resource encrypted with a key (310).

14. Method of decrypting at least part of a computer program element for enabling execution of said computer program element (402), comprising the steps of:
obtaining at least one static resource (406) encrypted with a first key (314), in a first entity (52),
providing said at least one encrypted static resource (406) to a second entity (54, step 208), and
obtaining by said first entity (52) said at least one static resource (430) from the second entity (54, step 210), where the encryption according to the first key (314) has been decrypted using a second key (422).

15. Method of decrypting, according to claim 14, further comprising the step of:
obtaining a third key (step 202),
decrypting the at least one encrypted static resource (430), by using the third key (step 212),
wherein which the step of providing (step 208) comprises providing the third key (404) and said at least one encrypted static resource (406, 410) to the second entity (54), and the step of obtaining (step 210) by said first entity (52) said at least one static resource (430) from the second entity (54), comprises obtaining the at least one static resource encrypted (430) with the third key (426), so that the computer program element can be executed.

16. Method of decrypting, according to claim 14, in which the third key (404, 432) is a random session key.

17. Method of decrypting, according to claim 14, further comprising the step of:
obtaining the first key (408),
encrypting the third key (408) and said at least one encrypted static resource (406), by using said first key(408, step 206),
and in which the step of providing (step 208) said at least one encrypted static resource (410) to the second entity (54) comprises providing said third key (404) and said at least one encrypted static resource (406), both encrypted (410) by using the first key (408).

18. Method of decrypting, according to claim 14, in which the first key (314, 408) and the second key (316) is the public and the private key, respectively, of a public/private key pair.

19. Method of decrypting at least part of a computer program element for enabling execution of said computer program element, comprising the steps of:
obtaining at least one encrypted static resource (414) from a first entity (52, step 218), which at least one static resource (306) has been encrypted by using a first key (314),
obtaining a second key (416, step 216),
decrypting said at least one encrypted static resource (418), by using said second key (416, step 222), and
providing said at least one static resource (424) to the first entity (52, step 228).

20. Method of decrypting, according to claim 19, further comprising the step of:
obtaining a third key (420) from the first entity (52),
encrypting the at least one static resource (424) by using the third key (426), and in which the step of providing (step 228) said at least one static resource (428) to the first entity (52) comprises providing said at least one static resource (428) encrypted with the third key (426).

21. Method of decrypting, according to claim 20, wherein the at least one encrypted static resource (406) and the third key (404), are obtained encrypted (414), which encryption has been made using the first key (314).

22. Method of decrypting, according to claim 21, further comprising the step of:
decrypting by using the second key (416) , the encrypted (414) at least one encrypted static resource (406) and the third key (404, step 220).

23. Method of decrypting according to claim 19, in which the first key (314) and the second key (416, 422) is the public and the private key, respectively, of a public/private key pair.

24. Method of decrypting according to claim 19, in which the third key (420, 426) is a random session key.

25. Computer program decryption device (52) for decrypting at least part of a computer program element (402) for enabling execution of said computer program element, said device being arranged to:
obtain at least one static resource (406) encrypted with a first key (314),
provide said at least one encrypted static resource (406) to a second entity (54, step 208), and
obtain from the second entity (54) said at least one static resource (430, step 210), where the encryption according to the first key (314) has been decrypted by using a second key (422).

26. Computer program decryption device (54) for decrypting at least part of a computer program element for enabling execution of said computer program element, said device being arranged to:
obtain at least one encrypted static resource (414) from a first entity (52, step 218), which at least one static resource (414) has been encrypted by using a first key (314),
obtain a second key (416, step 216),
decrypt said at least one encrypted static resource (418) by using the second key (422, step 222), and
provide said at least one static resource (424) to the first entity (52, step 228).

27. Computer program product comprising a computer readable medium, having thereon computer program code means, to make a computer execute, when said computer program code means is loaded in the computer:
obtaining at least one static resource (406) encrypted with a first key (314), in a first entity (52),
providing said at least one encrypted static resource (406) to a second entity (54, step 208), and
obtaining by said first entity (52) said at least one static resource (430) from the second entity (54, step 210), where the encryption according to the first key (314) has been decrypted by using a second key (422).

28. Computer program element comprising computer program code means to make a computer execute, when said computer program code means is loaded in the computer:
obtaining at least one static resource (406) encrypted with a first key (314), in a first entity (52),
providing said at least one encrypted static resource (406) to a second entity (54, step 208), and
obtaining by said first entity (52) said at least one static resource (430) from the second entity (54, step 210), where the encryption according to the first key (314) has been decrypted by using a second key (422).

29. Computer program product comprising a computer readable medium, having thereon computer program code means, to make a computer execute, when said program code means is loaded in the computer:
obtaining at least one encrypted static resource (414) from a first entity (52, step 218), which at least one static resource (414) has been encrypted by using a first key (314),
obtaining a second key (416) in a second entity (54, step 216),
decrypting said at least one encrypted static resource (418) by using the second key (422, step 222), and
providing said at least one static resource (424) to the first entity (52, step 228).

30. Computer program element comprising computer program code means to make a computer execute:
obtaining at least one encrypted static resource (414) from a first entity (52, step 218), which at least one static resource (414) has been encrypted by using a first key (314),
obtaining a second key (416) in a second entity (54, step 216),
decrypting said at least one encrypted static resource (418) by using the second key (422, step 222), and
providing said at least one static resource (424) to the first entity (52, step 228).
